(19) United States
(12) Patent Application Publication
(10) Pub. No.: US 2025/0317504 A1
(43) Pub. Date: Oct. 9, 2025

(54) PHYSICAL LAYER REGISTER ACCESS

(71) Applicant: Microchip Technology Incorporated, Chandler, AZ (US)

(72) Inventors: Lars Ellegaard, Copenhagen S (DK); Brian Branscomb, Hopkinton, MA (US)

(21) Appl. No.: 19/169,054

(22) Filed: Apr. 3, 2025

Related U.S. Application Data
(60) Provisional application No. 63/575,248, filed on Apr. 5, 2024.

(51) Int. Cl. H04L 69/323; G06F 9/30; H04L 12/40

(52) U.S. Cl. CPC H04L 69/323; G06F 9/30101; H04L 12/4015

(57) ABSTRACT

An apparatus includes: a physical layer device (PHY); a PHY management interface; and a multiport Ethernet device coupled with the PHY via the PHY management interface. The multiport Ethernet device may include: a processor; a set of registers accessible to the processor via an internal bus of the multiport Ethernet device; a management interface controller to construct management frames at the PHY management interface; and a logic circuit to initiate copy of data from a register of the PHY via the management interface controller and store copied PHY register data at the register of the multiport Ethernet device.

### CROSS-REFERENCE TO RELATED APPLICATIONS

This application claims the benefit under 35 U.S.C. § 119 (e) of U.S. Provisional Patent Application Ser. No. 63/575,248, filed Apr. 5, 2024, the disclosure of which is hereby incorporated herein in its entirety by this reference.

### FIELD

One or more examples relate, generally, to an apparatus comprising a physical layer device (PHY), a management data input/output bus, and an Ethernet switch. The Ethernet switch includes a register, a media-independent interface controller to facilitate read of data from a register of the PHY, and a logic circuit to copy data from the register of the PHY via the media-independent interface controller and store the copied data at the register.

### BACKGROUND

A controller may facilitate functions for a standard data interface between a physical layer device (PHY) and a media access control device (MAC) or Ethernet Switch and manage the PHY via a bus connection.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a apparatus capable of autonomous register access at one or more Ethernet physical layer devices (PHYs), in accordance with one or more examples.

FIG. 2 is a block diagram depicting a apparatus capable of autonomous register access at one or more PHY's via external registers connected to a connection of an Ethernet switch (or a connection of an apparatus that includes the Ethernet switch), in accordance with one or more examples.

FIG. 3 is a block diagram depicting an eMIIM scan function in accordance with one or more examples.

FIG. 4 is a block diagram depicting a logical association of a PHY register with a shadow register via a memory map, in accordance with one or more examples.

FIG. 5 is a communication protocol sequence diagram depicting a process of a scheduled read of multiple PHYs (in this specific example, PHY counters) involving a processor, an eMIIM controller, and one or more PHYs, in accordance with one or more examples.

FIG. 6 is a communication protocol sequence diagram depicting a process 600 of an event-driven read of one or more PHY registers involving a processor, eMIIM controller, one or more PHY registers, in accordance with one or more examples.

FIG. 7 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, apparatus, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer, including a processor, is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

Typically, an Ethernet physical layer device (PHY) may be accessed (e.g., controlled, read, without limitation) by a processor via an IEEE 802.3 MDIO (Management Data Input/Output)/MDC (Management Data Clock) interface where the processor issues synchronous commands (e.g., IEEE 802.3 multipoint MDIO/MDC Rd/Wr (Read/Write) @ 2.5 MHz-25 MHz, where 2.5 MHz is the highest common MDIO speed, without limitation). A synchronous read (a “synchronous register read”) of a PHY's registers by the processor via the MDIO/MDC interface are typically slow and block (e.g., prevents for some number of processing cycles, without limitation) the processor from performing other tasks while the read operation is ongoing. “Synchronous read” is a method of data transfer where a processor must wait for the read to complete before it can proceed with executing other tasks.

Some register reads are time critical—for example, retrieval of timestamps from transmitted IEEE 1588 PTP (Precision-Time-Protocol) frames. Other register reads, for diagnostic data (e.g., MACsec counters, functional safety, without limitation) involve regular transfer of large amounts of data. An internal main processor of an Ethernet switch has clock rates of hundreds of MHz to a few GHz. In synchronous register reads, the processor waits while the read is performed on the slow MDIO/MDC interface and is thus stalled during that period. A 100-bit timestamp read takes 200+microseconds (μs) when performed at a 2.5 MHz MDC clock speed. In a switch with many external PHYs and high PTP transmission rates, this blocking time puts a high load on the processor, to the extent that only a few ports can be served.

In one or more examples, a scanning function integrated into an enhanced MIIM (eMIIM) controller. The scanning function offloads the MDIO read operations from a processor by autonomously reading and caching data (including diagnostic counters and timestamps) into shadow registers, as discussed below. This reduces the effective processor blocking time to below 700 nanoseconds.

The scanning function is configured by the processor. During configuration, the processor may program the scanning function with predetermined parameters, including one or more of: register selection, read schedule, or event-triggers. In some examples, the processor may configure the scanning functions with one or more sets of predetermined parameters. Multiple distinct sets of parameters may be associated with different data types (e.g., operational data, diagnostic data, timestamps, regular occurring data, or other types of data, without limitation).

A counter is a specialized register which counts the number of applicable events, and this count may be utilized to track statistics. Counters are utilized within Ethernet PHYs (a PHY counter) to track statistics such as the number of transmitted or received packets, error events, or other metrics, and more generally in connection with recording operational or diagnostic information related to link performance and activity. These counters help higher-level systems functions (e.g., a CPU or network management software) monitor network health, diagnose issues, and optimize overall performance.

Once configured by the processor, the scanning function automatically (without intervention or supervision by the processor) performs scheduled and event-triggered MDIO read operations. On a schedule (e.g., a fixed schedule, without limitation) or in response to specific event triggers, the scanning function accesses PHY registers (via the MDIO/MDC interface) and transfers the retrieved data (e.g., the register data, without limitation) to corresponding shadow registers. The scanning function subsequently interrupts the processor only when the data is ready for retrieval, thereby obviating the need for continual processor intervention. This autonomous operation significantly reduces processor blocking time and permits concurrent execution of other processor tasks. A reduced blocking time at the processor may be realized compared to the synchronous read discussed above.

In the manner discussed above, this autonomous scanning function may hide the MDIO reading time, or MDIO reading time for specific types of data, from the processor.

The Media Independent Interface (MII) is a standard interface used to connect an Ethernet PHY to an Ethernet MAC. An MII allows transmission and reception of data between the PHY and MAC layers of Ethernet devices. MII was designed to be media-independent, meaning it can be used with multiple types of physical media (e.g., copper cables, fiber optics, twister pair, coaxial cable, without limitation), without requiring changes to the MAC hardware.

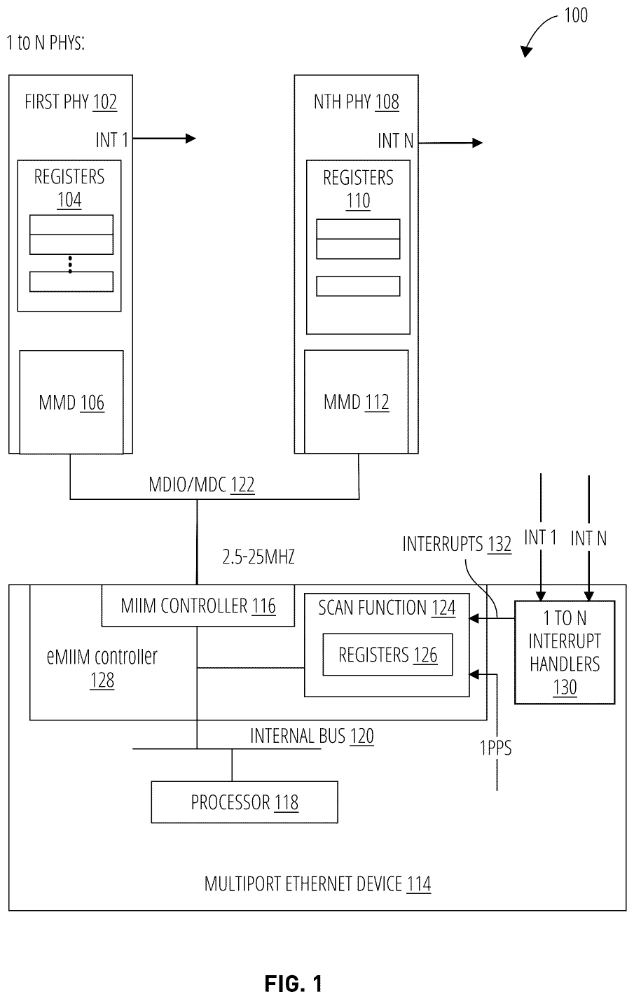

FIG. 1 is a block diagram depicting an apparatus 100 capable of autonomous register access at one or more Ethernet physical layer devices (PHYs), in accordance with one or more examples.

Apparatus 100 includes a multiport Ethernet device 114 and one or more PHY devices-represented here as First PHY 102 and Nth PHY 108—communicatively coupled over an MDIO/MDC 122 interface. Multiport Ethernet device 114 is a device including or capable of supporting more than one Ethernet port, such as an Ethernet switch, an Ethernet hub, a router with multiple Ethernet ports, network interface card with multiple Ethernet ports, or a network appliance with multiple Ethernet ports, without limitation. The multiport Ethernet device 114 includes a processor 118, 1 to N interrupt handlers 130, and an enhanced MII Management (eMIIM) controller 128, comprising a MIIM Controller 116 and a scan function 124. The processor 118 communicates with these internal controller blocks of the eMIIM controller 128 via an internal bus 120. Interrupt signals (INT 1, INT 2) from respective ones of the one or more PHYs may optionally be received by 1 to N interrupt handlers 130 of multiport Ethernet device 114. multiport Ethernet device 114 may include 1 to N interrupt handlers 130 for an implementation of an event-triggered read, as discussed herein.

Apparatus 100 may autonomously collect and deliver PHY register data to processor 118 without incurring the traditional overhead (e.g., blocking time, without limitation) associated with synchronous reads via an MDIO/MDC interface.

The 1 to N PHYs, represented in FIG. 1 as first PHY 102 and Nth PHY 108, are physical layer devices that convert digital signals to appropriate analog waveforms (and vice versa) for transmission and reception over a physical medium (e.g., a twisted pair or other cable, without limitation). Respective PHYs include registers 104/110 and MDIO Manageable Device (MMD) 106/112. Registers 104/110 may be utilized to store information such as link status, error counters, timestamps (for time-sensitive protocols such as IEEE 1588, without limitation), and other PHY-specific data, without limitation. The MMDs implement the IEEE 802.3-defined MDIO management interface portion of MDIO/MDC 122. The MMDs decode MDIO commands (e.g., commands for read/write transactions, without limitation), retrieve the corresponding register data from registers 104/110, and respond to the controlling entity—in this case, eMIIM controller 128.

MDIO/MDC 122 is a management interface as defined by IEEE 802.3 for reading from and writing to PHY registers. MDC is the clock line, while MDIO is the data line. Read and write operations are serialized; each bit is clocked in or out of the PHY over MDIO, synchronized by MDC clock. MDIO/MDC 122 interface supports multiple PHYs, each having a unique address, enabling centralized control from a single controller—in this case, eMIIM controller 128.

Enhanced media independent interface (MII) management controller 128 (eMIIM controller 128) is a management interface controller. eMIIM controller 128 implements a management portion of an MII interface, which manages register access operations (e.g., read, write, without limitation) of PHYs via the MDIO/MDC 122. eMIIM controller 128 enhances a standard MIIM controller (here, the standard MIIM controller is MIIM Controller 116) with additional logic, specifically scan function 124.

MIIM Controller 116 of eMIIM controller 128 is a management interface controller, which implements standard MII management operations as defined by 802.3, including MDIO register read or an MDIO register write, without limitation. MIIM controller 116 generates bit-level signaling on the MDIO line of MDIO/MDC 122 to construct MDIO management frames (i.e., having a management frame structure as defined by 802.3 Clause 22.2.4) for standard MII management operations, such as to read or write the contents of configuration or status registers used by higher-layer management functions, without limitation. MIIM Controller 116 constructs MDIO management frame formats and orchestrates their transmission at clock rates of the MDC clock of MDIO/MDC 122.

For example, when the MIIM controller 116 initiates an MDIO register read or write, it generates an MDIO management frame (sometimes an MDIO management frame is called an “MDIO transaction” or “MDIO command”). Specifically, the MIIM controller 116 transmits a command portion of the frame, which includes a preamble, a start-of-frame, an operation code (an indication of the type of MDIO transaction (e.g., read or write, without limitation)), a PHY address, and a register address. The MDIO management frame may optionally also include other specific data fields depending on specific operating conditions. After transmission of this command portion, there is a turnaround period (a duration of time measured, as a non-limiting example, in bit time or number of bits) during which the MIIM controller 116 releases control of the MDIO line of MDIO/MDC 122. During the turnaround period and following bits, the PHY's MMD (e.g., MMD 106 or MMD 112, without limitation) decodes this command, accesses the specified register and register data, and drives the MDIO line to transmit the register data to the MIIM controller 116.

In one or more examples, the MIIM controller 116 may construct and send MDIO management frames, including those for MDIO register reads and writes, without limitation, in response to requests or in responses to commands from higher-level logic such as scan function 124 or processor 118. Via use of such higher-level commands, MIIM controller 116 may initiate an MDIO register read or an MDIO register write under higher-level control of the processor 118 or the scan function 124.

Scan function 124 is a logic circuit (e.g., implemented in hardware, firmware, or both) integrated with eMIIM controller 128, and it serves as the logic for autonomously managing PHY register access via MIIM controller 116, and MDIO/MDC 122 as discussed herein.

In one or more examples, once configured (e.g., programed, without limitation) by processor 118, scan function 124 may autonomously initiate copying of register data from respective PHY registers of the 1 to N PHYs to registers 126. More specifically, scan function 124 may issue commands to read data from a PHY's registers (a “PHY register read”). More specifically, scan function 124 may issue commands, in response to which, MIIM Controller 116 initiates MDIO register reads. In one or more examples, scan function 124 may initiate copying of register data at scheduled intervals (e.g., based on an internal timer or a 1 PPS reference, without limitation), in response to detecting specific events or interrupts (e.g., a timestamp-ready signal, without limitation), or both. Upon receiving PHY register data from the MIIM Controller 116, scan function 124 stores the data in registers 126 or buffers (dubbed herein as “shadow registers”) accessible to the processor 118 via internal bus 120. In the case of scheduled reads, scan function 124 may initiate copying at set (e.g., preset, without limitation) time intervals. In the case of triggered copying, the scan function 124, in response to a predetermined trigger, may initiate copying of PHY register data associated with the trigger.

Registers 126 of scan function 124 store copies of register data (“copied PHY register data”) retrieved from respective ones of the 1 to N PHYs (e.g., from registers 104 and registers 110, without limitation). In one or more examples, the register data at a respective PHY that is copied may include some or a totality of register data at a respective PHY register. Copied PHY register data may include, as a non-limiting examples, timestamp data or status reporting data. In one or more examples, shadow register data stored at registers 126 may be updated in response to an event, according to a schedule, or both.

In one or more examples, the trigger in response to which the scan function 124 initiates copying of data from a PHY's register may be an assertion of an interrupt (INT) associated with a PHY (in this specific example, INT1 of first PHY 102 or INT N of Nth PHY 108). In one or more examples, respective INTs of the PHYs may be coupled to multiport Ethernet device 114, eMIIM controller 128, or scan function 124. The 1 to N interrupt handlers 130 at the multiport Ethernet device 114 may be pre-associated with the respective ones of the 1 to N PHYs to identify which PHY should have its registers read.

Scheduled Reads Aligned with Timing Reference

In one or more examples, the scan function 124 may be configured to initiate copying of register data based on a predetermined schedule and a timing reference, such as the 1PPS (one pulse per second) signal, without limitation. A 1PPS signal is a highly accurate timing signal that produces one pulse every second. Notably, the 1PPS signal is used in this description merely by way of non-limiting example to illustrate a highly accurate timing reference. It is expressly contemplated that the timing reference may be derived from a variety of sources, including but not limited to an external GPS receiver, an atomic clock, or via protocols such as PTP, gPTP, or NTP, or even from an internal system time tick. Moreover, the timing reference need not produce one pulse per second; any periodic or aperiodic timing signal, whether regular or irregular intervals, exhibiting any pulse frequency or frequencies may be employed without exceeding the scope. This disclosure is not limited to a 1PPS signal or any particular periodicity or pulse frequency.

In the case of a scheduled read, scan function 124 is programmed with the desired read interval (e.g., every microsecond, or a fraction or multiple thereof, without limitation) and PHY information (e.g., addresses of registers to be copied, without limitation). Upon each pulse of the timing reference, scan function 124 commands MIIM Controller 116 to perform an MDIO read of selected PHY registers-such as counters, diagnostic information, or other status data. The resulting data is transferred through the MDIO/MDC 122 to eMIIM controller 128 and scan function 124 and made available to the processor 118 via internal bus 120. As a non-limiting example, the data may be made available to processor 118 by storage in registers 126, which are accessible to processor 118 via internal bus 120. Because the scan function 124 manages the timing and read operations autonomously, the processor 118 is not blocked during these scheduled reads, reducing overhead while ensuring regular updates (e.g., for statistics collection or diagnostic monitoring).

### Event-Triggered Reads via Interrupt Handlers

In addition to, or as an alternative to. scheduled reads, apparatus 100 supports an event-driven mechanism that leverages 1 to N interrupt handlers 130 within multiport Ethernet device 114. Each PHY (e.g., First PHY 102 or Nth PHY 108) may assert a dedicated interrupt signal (INT 1 . . . . INT N) to indicate the occurrence of a time-critical event, such as the availability of a newly captured timestamp. The 1 to N interrupt handlers 130 receive respective interrupts of the PHYs, identify the source PHY, and forward an interrupt notification 132 to the scan function 124. The interrupt notification 132 identifies the type of interrupt and the source PHY. In response, the scan function 124 commands the MIIM Controller 116 to perform an MDIO read of the pertinent PHY registers, retrieving the event-specific data (e.g., timestamps). The retrieved PHY register data is stored in registers 126, which may trigger a notification (e.g., an interrupt, without limitation) to the processor 118 indicating that PHY register data is available to be read from registers 126.

As a non-limiting example, autonomous register reads discussed herein may be used to read a variety of register data being used for a variety of purposes, this disclosure is not limited to any specific one. For example, autonomous register reads may be utilized to read operational or diagnostic data about the status of a PHY or Ethernet link, for timestamp retrieval (2-step, IEEE 802.1AS), or both.

In some cases (as a non-limiting example, in high-density systems where numerous PHYs are used, without limitation), providing a dedicated interrupt line for each PHY may significantly increase hardware complexity and consume valuable pin resources.

In one or more examples, interrupt signals are aggregated into one or more external registers and connected to a single connection (or in some cases, connections numbering fewer than the number of interrupts), and a serial controller (e.g., a single GPIO connection and a serial GPIO controller, without limitation) reads their status. Such a design reduces the number of required interrupt pins, thereby simplifying the interconnection between PHYs and the switch and streamlining the initiation of targeted MDIO transactions based on detected events.

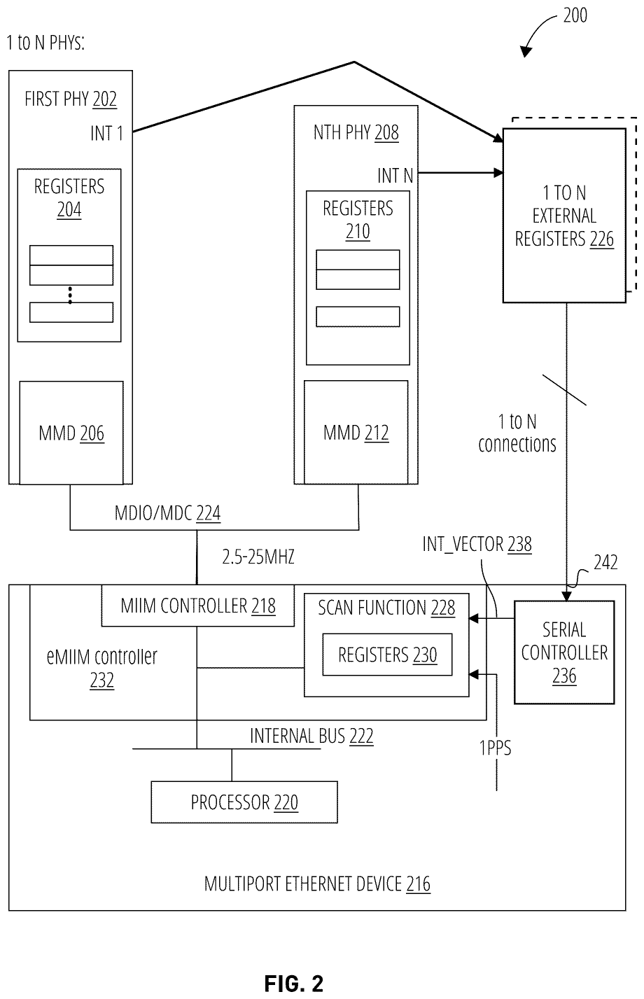

FIG. 2 is a block diagram depicting an apparatus 200 capable of autonomous register access at one or more PHYs via external registers connected to a connection of an Ethernet switch (or a connection of an apparatus or system that includes the Ethernet switch), in accordance with one or more examples.

FIG. 2 depicts a specific example that builds on concepts shown in FIG. 1 and further introduces 1 to N external registers 226 and a serial controller 236. Unless otherwise noted, elements in FIG. 2 bearing the part name as in FIG. 1 may be understood to function in a substantially similar manner as their counterpart in FIG. 1.

In the example depicted by FIG. 2, the state of an INT of a respective PHY is transferred to Ethernet switch 216 via an external register and a connection connected to a serial controller. The scan function 228 reads the state information about the interrupts of the various PHYs and copies registers of the PHYs as indicated by the state information.

In FIG. 2, First PHY 202 and Nth PHY 208 each include registers and MMDs just like the PHYs in FIG. 1. However, in this example, the INT 1 . . . . INT N signals are routed to 1 to N External Registers 226 rather than being input directly into dedicated interrupt handlers within the Ethernet switch 216. The external registers 226 aggregate or latch these interrupt signals from multiple PHYs, and the serial controller 236—which is part of or communicatively coupled to the eMIIM controller 232—periodically reads or polls these external registers 226 over a serial interface (e.g., SPI or I2C, without limitation). When one of the external registers 226 indicates that a PHY has asserted an interrupt, the scan function 228 is notified via INT_vector 238 and may initiate an MDIO read of the pertinent PHY register(s) in response thereto.

This design allows the apparatus 200 to handle event-based triggers with minimal pin usage and without requiring each PHY to have a dedicated interrupt input on the Ethernet switch. The external registers 226 thus serve as a centralized repository for interrupt status information, while the serial controller 236 ensures that the scan function 228 can rapidly detect and respond to new events. Once the scan function 228 retrieves the data (e.g., timestamps or diagnostic counters) via the MIIM Controller 218, it stores the data in local shadow registers (registers 230) and optionally notifies the Processor 220 via internal bus 222. Consequently, apparatus 200 achieves both scheduled and event-driven data collection with reduced CPU blocking time, similarly to FIG. 1, but with the added flexibility of external register-based interrupt aggregation.

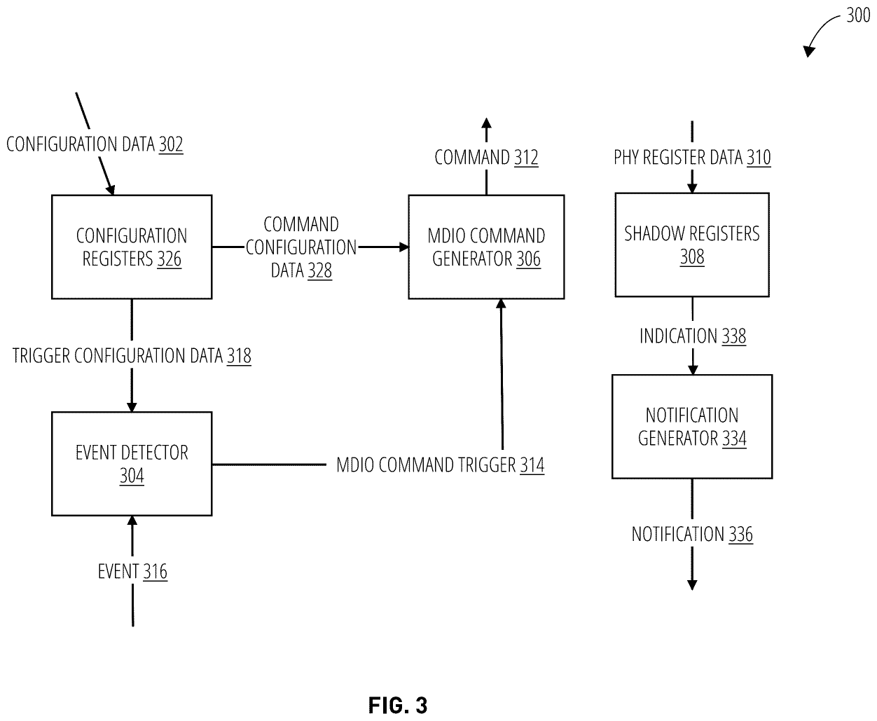

FIG. 3 is a block diagram depicting an eMIIM scan function 300, in accordance with one or more examples. The scan function is suitable for use within an enhanced MII management controller that performs register reads autonomously and is a non-limiting example of scan function 124 and scan function 228.

The illustrated arrangement may operate in a scheduled manner, an event-driven manner, or a combination thereof, depending on specific operational context. Although the following description references reads, it will be understood by those skilled in the art that write operations may be implemented similarly, subject to the requirements of a given design.

The eMIIM scan function 300 includes an MDIO command generator 306, shadow registers 308, notification generator 334, event detector 304, and configuration registers 326.

The Configuration Registers 326 store parameters (collectively referred to as Configuration Data 302) that define how and when the scanning function initiates MDIO transactions. These parameters may include addresses of PHY registers to be accessed, timing intervals, or event-trigger criteria. In one or more examples, the processor of the Ethernet switch writes the configuration data 302 into configuration registers 326 to program eMIIM scan function 300. The stored configuration data 302 is then available to event detector 304 and MDIO Command Generator 306, and optionally other blocks as Command Configuration Data 328 or Trigger Configuration Data 318, discussed below.

Event detector 304 monitors external signals (such external signals collectively shown as event 316) to determine if an MDIO access operation should be initiated. These signals may include pulses from a timing reference (e.g., from a 1PPS source, without limitation) for scheduled reads, interrupt lines or interrupt notifications that indicate interrupts one or more PHY devices, or other system-level triggers.

Event detector 304 uses trigger configuration data 318—received from configuration registers 326—to interpret and filter the incoming event 316. Upon detecting a valid trigger condition (e.g., a rising/falling edge of a timing pulse, an interrupt assertion, or another specified event, without limitation), the event detector 304 issues MDIO command trigger 314 to the MDIO command generator 306. This mechanism supports solely scheduled operation, solely event-driven operation, or a hybrid of both, depending on eMIIM scan function 300's configuration parameters.

MDIO command generator 306, based on the triggers and configuration data it receives, generates commands to for the MIIM controller to initiate MDIO access operations, and more specifically generation of the low-level MDIO read or write commands to one or more PHYs by the MIIM controller.

MDIO command generator 306 retrieves command configuration data 328 from configuration registers 326, which specifies which PHY registers to access and how to format the MDIO transaction. MDIO command generator 306 outputs a command 312 to a standard MIIM controller block, the command to initiate transfer of PHY register data from a PHY to the shadow registers 308.

Shadow registers 308 receive and store the PHY register data 310 transferred from a PHY. This local storage allows the processor of the Ethernet switch to retrieve the updated data at high speed, avoiding repeated or blocking MDIO operations.

Notification generator 334, in response to indication 338, signals to the processor (or another controller or host logic) that PHY register data is available at shadow registers 308 via notification 336.

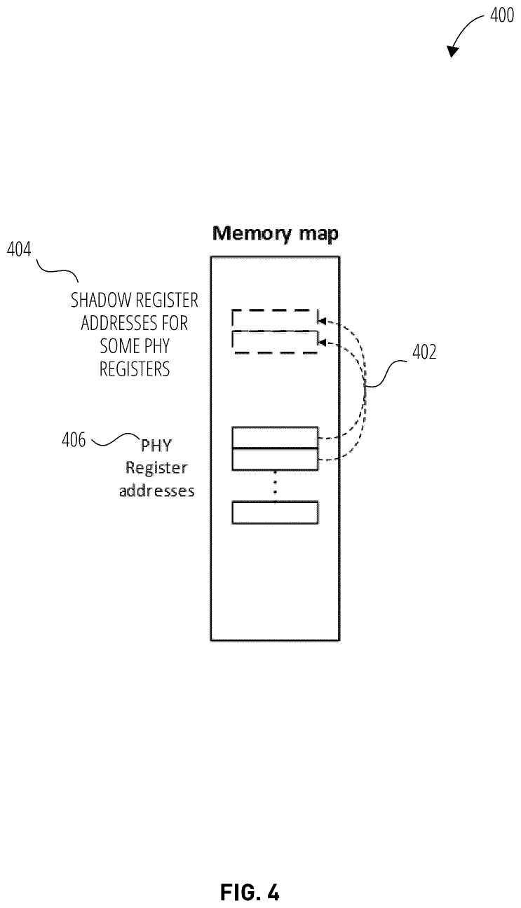

FIG. 4 is a block diagram depicting a logical association of a PHY register with a shadow register via a memory map 400, in accordance with one or more examples. In this specific example, the addresses of one or more PHY registers (PHY register addresses 406) are associated with the addresses of one or more shadow registers (shadow register addresses 404). Shadow registers, sets of addresses of PHYs, or both, may be associated with specific PHYs via memory map 400 and the scan function 124 may determine which PHYs are associated with copied register data at the shadow registers.

Dashed lines or arrows 402 in FIG. 4 denote the logical association between specific PHY register addresses and corresponding shadow registers. The processor may read from these shadow registers at high speed, using the same or similar address references it would use for direct PHY access. However, because the shadow registers reside on an internal bus or in local memory, the processor avoids the long latencies normally associated with MDIO transactions.

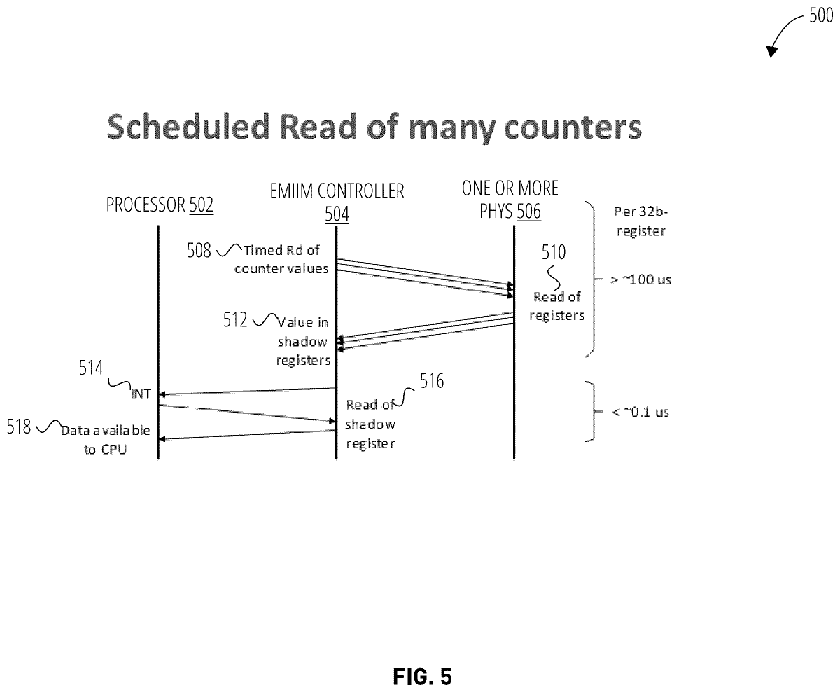

FIG. 5 is a communication protocol sequence diagram depicting a process 500 of a scheduled read of multiple PHYs (in this specific example, PHY counters) involving a processor 502, an eMIIM controller 504, and a one or more PHYs 506, in accordance with one or more examples.

At a predefined interval of a schedule, eMIIM controller 504 initiates a read operation of register data (in this specific non-limiting example, counter values) from the one or more PHYs 506, at operation 508. Because each register in the one or more PHYs 506 is accessed over a relatively slow MDIO bus, the read operation at operation 510 may require on the order of tens or hundreds of microseconds. During this time interval, the processor 502 remains unblocked, allowing it to perform other tasks. Once the eMIIM controller 504 receives PHY register data from the one or more PHYs 506, the eMIIM controller 504 writes the retrieved PHY register data into local shadow registers, at operation 512, and notifies the processor 502 that the PHY register data is available at the shadow registers at operation 514. The processor 502 subsequently reads from these shadow registers, at operation 516. Because these shadow registers reside on a high-speed internal bus coupling the processor 502 and the eMIIM controller 504, the processor 502 can retrieve the updated data, indicated at reference 516, orders of magnitude less time than the time interval of the read operation. At operation 518, the data is made available to the processor 502, completing the scheduled read cycle. Offloading the slow MDIO transactions to the eMIIM controller 504 reduces the blocking time while ensuring the processor 502 has rapid access to updated PHY counters once the read operations are complete.

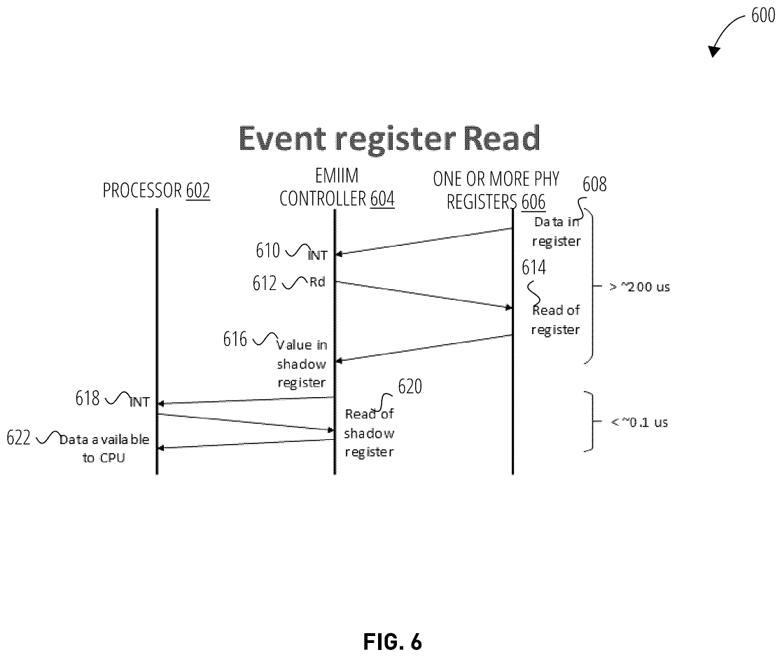

FIG. 6 is a communication protocol sequence diagram depicting a process 600 of an event-driven read of one or more PHY registers involving a processor 602, eMIIM controller 604, one or more PHY registers 606, in accordance with one or more examples.

In the specific event-driven register read process 600 depicted by FIG. 6 a processor 602, an eMIIM controller 604, and a PHY interact to retrieve PHY register data in response to an event (here, an interrupt signal). At operation 608, new or updated data is in one or more registers 606 of a PHY (“one or more PHY registers 606”). At operation 610, the PHY asserts an interrupt (INT) line to indicate that new or updated data is available at its register, such as a timestamp or diagnostic counter value. At operation 612, the eMIIM controller 604 issues an MDIO read command to the PHY, initiating a data transfer that can require approximately twenty microseconds for each 32-bit register at standard MDIO clock rates. At operation 614, the PHY, in response to the MDIO read command, transmits the requested PHY register data. At operation 616, the eMIIM controller 604 receives the PHY register data from the PHY and writes the received PHY register data to one or more shadow registers. In operation 616, the eMIIM controller 604. At operation 618, the eMIIM controller 604 notifies the processor 602 that the PHY register data is available at the shadow registers. At operation 620, the processor 602 performs a high-speed read (a read over the high-speed internal bus) of the shadow register to retrieve the PHY register data. At operation 622, the newly obtained data becomes available for further processing or system-level tasks.

By confining the slower MDIO transactions to the eMIIM controller 604, the processor 602 remains unblocked until the data has been fully retrieved, thereby reducing latency and improving efficiency in time-sensitive applications.

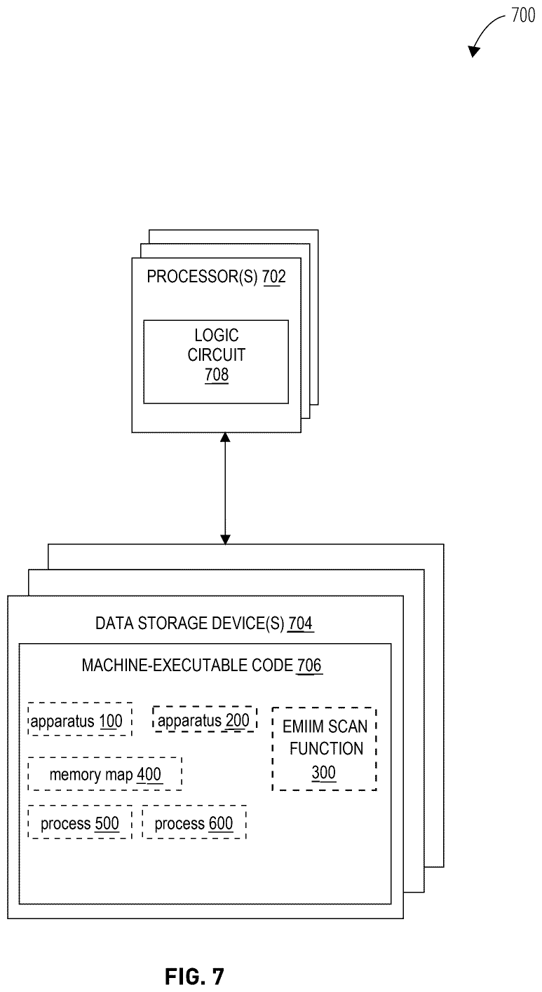

It will be appreciated by those of ordinary skill in the art that functional elements of examples disclosed herein (e.g., functions, operations, acts, processes, or methods) may be implemented in any suitable hardware, software, firmware, or combinations thereof. FIG. 7 illustrates non-limiting examples of implementations of functional elements disclosed herein. In some examples, some or all portions of the functional elements disclosed herein may be performed by hardware capable of carrying out the functional elements.

FIG. 7 is a block diagram of a circuitry 700 that, in some examples, may be used to implement various functions, operations, acts, processes, or methods disclosed herein. The circuitry 700 includes one or more processors 702 (sometimes referred to herein as “processors 702”) operably coupled to one or more data storage devices 704 (sometimes referred to herein as “storage 704”). The storage 704 includes machine-executable code 706 stored thereon and the processors 702 include logic circuit 708. The machine-executable code 706 includes information describing functional elements that may be implemented by (e.g., performed by) the logic circuit 708. The logic circuit 708 is adapted to implement (e.g., perform) the functional elements described by the machine-executable code 706. The circuitry 700, when executing the functional elements described by the machine-executable code 706, should be considered as special purpose hardware for carrying out functional elements disclosed herein. In one or more examples, the processors 702 may perform the functional elements described by the machine-executable code 706 sequentially, concurrently (e.g., on one or more different hardware platforms), or in one or more parallel process streams.

When implemented by logic circuit 708 of the processors 702, the machine-executable code 706 adapts the processors 702 to perform operations of examples disclosed herein. By way of non-limiting example, the machine-executable code 706 may adapt the processors 702 to perform some or a totality of operations of one or more of: process 500 or process 600.

Also, by way of non-limiting example, the machine-executable code 706 may adapt the processors 702 to perform some or a totality of features, functions, or operations disclosed herein for one or more of: apparatus 100, apparatus 200, eMIIM scan function 300, or memory map 400. More specifically, first PHY 102, registers 104, MMD 106, Nth PHY 108, registers 110, MMD 112, MDIO/MDC 122, multiport Ethernet device 114, eMIIM controller 128, MIIM controller 116, scan function 124, registers 126, internal bus 120, processor 118, 1 to N interrupt handlers 130, or a source of a timing reference IPPS-of FIG. 1; or first PHY 202, registers 204, MMD 206, Nth PHY 208, registers 210, MMD 212, external registers 226, MDIO/MDC 224, Ethernet switch 216, eMIIM controller 232, MIIM Controller 218, scan function 228, registers 230, internal bus 222, processor 220, serial controller 236, or a source of timing reference IPPS-of FIG. 2.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device (PLD), discrete gate or transistor logic, discrete hardware components, other programmable device, or any combination thereof designed to perform the functions disclosed herein. A general-purpose computer including one or more processors 702, including a general-purpose processor, is considered a special-purpose computer at least while the general-purpose computer executes functional elements corresponding to the machine-executable code 706 (e.g., software code, firmware code, configuration data, hardware descriptions, without limitation) related to examples of the present disclosure. It is noted that a general-purpose processor (which may also be referred to herein as a host processor or simply a host) may be a microprocessor, but in the alternative, a general-purpose processor of processors 702 may include any conventional processor, controller, microcontroller, or state-machine. An FPGA or other PLD of the processors 702 may be configured (e.g., programmed, without limitation) with configuration data to perform functions disclosed herein, or, additionally or alternatively, may be capable of being configured or re-configured (e.g., programmable, or re-programmable, without limitation) with configuration data to perform functions disclosed herein. The processors 702 may also be implemented as a combination of computing devices, such as a combination of a DSP and a microprocessor, a plurality of microprocessors, one or more microprocessors in conjunction with a DSP core, or any other such configuration.

In one or more examples the storage 704 includes volatile data storage (e.g., random-access memory (RAM), static RAM (SRAM), without limitation), non-volatile data storage (e.g., Flash memory, a hard disc drive, a solid-state drive, erasable programmable read-only memory (EPROM), without limitation). In some examples the processors 702 and the storage 704 may be implemented into a single device (e.g., a semiconductor device product, a system on chip (SOC), without limitation). In some examples the processors 702 and the storage 704 may be implemented into separate devices.

In one or more examples the machine-executable code 706 may include computer-readable instructions (e.g., software code, firmware code). By way of non-limiting example, the computer-readable instructions may be stored by the storage 704, accessed directly by the processors 702, and executed by the processors 702 using at least the logic circuit 708. Also, by way of non-limiting example, the computer-readable instructions may be stored on the storage 704, transferred to a memory device (not shown) for execution, and executed by the processors 702 using at least the logic circuit 708. Processors 702 or logic circuit 708 thereof be coupled to such a memory device or include such a memory device (e.g., a configuration memory cell, without limitation). Accordingly, in some examples the logic circuit 708 includes electrically configurable logic circuit 708.

In one or more examples the machine-executable code 706 may describe hardware (e.g., circuitry) to be implemented in the logic circuit 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very-large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 706 may include an HDL, an RTL, a GL description, a mask level description, other hardware description, or any combination thereof.

In examples where the machine-executable code 706 includes a hardware description (at any level of abstraction), a system (not shown, but including the storage 704) implements the hardware description described by the machine-executable code 706. By way of non-limiting example, the processors 702 may include a programmable logic device (e.g., an FPGA or a PLC, without limitation) and the logic circuit 708 may be electrically controlled (e.g., via configuration data, without limitation) to implement circuitry corresponding to the hardware description into the logic circuit 708. Also, by way of non-limiting example, the logic circuit 708 may include hard-wired logic manufactured by a manufacturing system (not shown but including the storage 704) according to the hardware description of the machine-executable code 706.

Regardless of whether the machine-executable code 706 includes computer-readable instructions or a hardware description, the logic circuit 708 is adapted to perform the functional elements described by the machine-executable code 706 when implementing the functional elements of the machine-executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a physical layer device (PHY); a PHY management interface that supports sequential transactions; and a multiport Ethernet device coupled with the PHY via the PHY management interface, the multiport Ethernet device including: a processor; a set of registers accessible to the processor via an internal bus of the multiport Ethernet device; a management interface controller to construct management frames at the PHY management interface; and a logic circuit to initiate copy of data from a register of the PHY via the management interface controller and store copied PHY register data into the register set of the multiport Ethernet device.

Example 2: The apparatus according to Example 1, wherein the logic circuit to initiate copying of data from the register of the PHY without intervention or supervision by the processor of the multiport Ethernet device.

Example 3: The apparatus according to any of Examples 1 and 2, wherein copy of data from the register of the PHY is a non-blocking, asynchronous copy with respect to the processor's operation.

Example 4: The apparatus according to any of Examples 1 through 3, wherein the logic circuit to initiate copying of data in response to a predetermined trigger.

Example 5: The apparatus according to any of Examples 1 through 4, wherein the predetermined trigger is an interrupt from the PHY.

Example 6: The apparatus according to any of Examples 1 through 5, wherein the logic circuit to initiate copying of data in response to event-driven triggering.

Example 7: The apparatus according to any of Examples 1 through 6, wherein at the predetermined trigger comes at regular intervals as indicated by a timing reference signal.

Example 8: The apparatus according to any of Examples 1 through 7, wherein the timing reference signal comprises a one pulse per second (1PPS) signal received from an external timing source.

Example 9: The apparatus according to any of Examples 1 through 8, wherein the multiport Ethernet device is coupled to an interrupt of the PHY, and the logic circuit to initiate copy of data from the PHY at least partially responsive to assertion of the interrupt of the PHY.

Example 10: The apparatus according to any of Examples 1 through 9, comprising: one or more registers coupled to a single input of the multiport Ethernet device, the one or more registers coupled to receive and store interrupts of one or more PHYs of the apparatus; wherein a serial controller of the multiport Ethernet device, in response to a driven interrupt at a connection, identifies a respective PHY associated with the driven interrupt and provides interrupt information to the logic circuit, the interrupt information including the identified PHY and a status of the driven interrupt.

Example 11: A method, comprising: initiating a read of a register of a PHY coupled to a multiport Ethernet device at least partially responsive to a command generated without intervention or supervision of a processor of the multiport Ethernet device, the read initiated via a PHY management interface that supports sequential transactions; and storing register data of the PHY in a set of registers of the multiport Ethernet device, the register data transferred to the multiport Ethernet device by a read via a PHY management interface, the register accessible to the processor of the multiport Ethernet device.

Example 12: The method according to Example 11, comprising generating the command at least partially responsive to a predetermined trigger.

Example 13: The method according to any of Examples 11 and 12, comprising generating the command at least partially responsive to event-driven triggering.

Example 14: The method according to any of Examples 11 through 13, wherein the predetermined trigger is an interrupt from the PHY.

Example 15: The method according to any of Examples 11 through 14, comprising generating the command at least partially responsive to a predetermined schedule and a timing reference signal.

Example 16: The method according to any of Examples 11 through 15, wherein the timing reference signal comprises a one pulse per second (1PPS) signal received from an external timing source.

Example 17: The method according to any of Examples 11 through 16, comprising: detecting a driven interrupt at a connection of the multiport Ethernet device; identifying the PHY as associated with the driven interrupt; and generating the command responsive to which the MDIO read is initiated at least partially responsive to the identified PHYS.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a physical layer device (PHY);
a PHY management interface that supports sequential transactions; and
a multiport Ethernet device coupled with the PHY via the PHY management interface, the multiport Ethernet device including:
a processor;
a set of registers accessible to the processor via an internal bus of the multiport Ethernet device;
a management interface controller to construct management frames at the PHY management interface; and
a logic circuit to initiate copy of data from a register of the PHY via the management interface controller and store copied PHY register data into the register set of the multiport Ethernet device.

2. The apparatus of claim 1, wherein the logic circuit to initiate copying of data from the register of the PHY without intervention or supervision by the processor of the multiport Ethernet device.

3. The apparatus of claim 1, wherein copy of data from the register of the PHY is a non-blocking, asynchronous copy with respect to the processor's operation.

4. The apparatus of claim 1, wherein the logic circuit to initiate copying of data in response to a predetermined trigger.

5. The apparatus of claim 4, wherein the predetermined trigger is an interrupt from the PHY.

6. The apparatus of claim 1, wherein the logic circuit to initiate copying of data in response to event-driven triggering.

7. The apparatus of claim 4, wherein at the predetermined trigger comes at regular intervals as indicated by a timing reference signal.

8. The apparatus of claim 6, wherein the timing reference signal comprises a one pulse per second (1PPS) signal received from an external timing source.

9. The apparatus of claim 1, wherein the multiport Ethernet device is coupled to an interrupt of the PHY, and the logic circuit to initiate copy of data from the PHY at least partially responsive to assertion of the interrupt of the PHY.

10. The apparatus of claim 1, comprising:
one or more registers coupled to a single input of the multiport Ethernet device, the one or more registers coupled to receive and store interrupts of one or more PHYs of the apparatus;
wherein a serial controller of the multiport Ethernet device, in response to a driven interrupt at a connection, identifies a respective PHY associated with the driven interrupt and provides interrupt information to the logic circuit, the interrupt information including the identified PHY and a status of the driven interrupt.

11. A method, comprising:
initiating a read of a register of a PHY coupled to a multiport Ethernet device at least partially responsive to a command generated without intervention or supervision of a processor of the multiport Ethernet device, the read initiated via a PHY management interface that supports sequential transactions; and
storing register data of the PHY in a set of registers of the multiport Ethernet device, the register data transferred to the multiport Ethernet device by a read via a PHY management interface, the register accessible to the processor of the multiport Ethernet device.

12. The method of claim 11, comprising generating the command at least partially responsive to a predetermined trigger.

13. The method of claim 11, comprising generating the command at least partially responsive to event-driven triggering.

14. The method of claim 12, wherein the predetermined trigger is an interrupt from the PHY.

15. The method of claim 11, comprising generating the command at least partially responsive to a predetermined schedule and a timing reference signal.

16. The method of claim 15, wherein the timing reference signal comprises a one pulse per second (1PPS) signal received from an external timing source.

17. The method of claim 11, comprising:
detecting a driven interrupt at a connection of the multiport Ethernet device;
identifying the PHY as associated with the driven interrupt; and
generating the command responsive to which the MDIO read is initiated at least partially responsive to the identified PHYS.
